(19) United States
(12) Patent Application Publication
(10) Pub. No.: US 2009/0094117 A1
(43) Pub. Date: Apr. 9, 2009

(54) NATURAL TARGETED ADVERTISING ENGINE

(76) Inventor: Jon Scott Zaccagnino, Flemington, NJ (US)

Correspondence Address: JOHN F. LETCHFORD, ARCHER & GREINER, P.C., ONE CENENNIAL SQUARE, HADDONFIELD, NJ, 08033, US

(21) Appl. No.: 12/246,722

(22) Filed: Oct. 7, 2008

Related U.S. Application Data
(60) Provisional application No. 60/978,616, filed on Oct. 9, 2007.

(51) Int. Cl. G06Q 30/00

(52) U.S. Cl. 705/14

(57) ABSTRACT

A method and system for categorizing information in a Web-based system based upon natural words and geographic which is then used to match the information with relevant advertising. The method and system allows advertisers to precisely target their ads based upon the relevancy and location of information which create a high probability of success for the ads. The system and method also presents information providers with an easy-to-use interface and process for quickly categorizing and assigning their information with one or more geographic locations so that it has a higher probability of reaching intended audiences.

### CROSS REFERENCE TO RELATED APPLICATION

This application claims the benefit of U.S. patent application Ser. No. 60/978,616, filed Oct. 9, 2007, which is incorporated herein by reference in its entirety.

### FIELD OF THE INVENTION

The present invention relates in general to Web-based advertising systems and methods and in particular to systems and methods for targeting Web advertising to local geographic regions based on author-inputted and system generated automated content.

### BACKGROUND OF THE INVENTION

The biggest challenge for any advertiser, whether in printed media or Web-based/Internet media, is to prominently position its advertisements (or ads) before those people who are more likely to read and take action on the ads. The key to doing so is to place the ad in close physical proximity to information that is relevant to the ad. This, in turn, increases the likelihood that the ad is not only read by but is interesting to the people reading the associated information. For example, a soccer store would typically want its ad for soccer cleats positioned adjacent to a sports story, video or score, most preferably near a soccer story, video or score. With the advent of the World Wide Web (Web) this challenge was supposed to be solved and, in some ways, it has improved. Yet, when it comes to a local advertiser that wants to target its ads to a relevant local audience, the Web presents a greater challenge than traditional media because it is global in scope and the way people find information on the Web is subjective.

The challenge is complicated because of two characteristics unique to the Web that make it difficult to match advertising to local geographic information on the Web. First, when most people publish local geographic information on the Web they are not doing so with the intent of attracting advertisers. They generally do not index or “tag” their data to describe who may be interested in an article or information let alone who might want to advertise in association with it. Tagging information to help others find it is useful and is being used on the Web. However, it is subjective and limited in scope since there is rarely an incentive to go into detail about the information. Furthermore, the investment in time necessary to properly index the information is usually much greater than the return on the time investment.

Second, most Web advertising engines that match ads to information use keyword algorithms to determine the relevancy of a piece of information. This is an attempt to automate the data tagging process discussed above. However, a significant problem with current advertising engines is that they do not adequately take into consideration the geographic location to which a piece of information may be most relevant. In addition, keywords culled by presently existing Web advertising engines oftentimes have different meanings in different geographic locations.

For instance, for an Internet article about “cheese steak grinders”, typical ad engines would—in respect to Philadelphia, Pa.—match ads containing the terms “cheese”, “steak”, “cheese steak” and “grinder”. The problem is, in the Philadelphia, Pa. metropolitan area, the word “grinder” is a synonym for a sub (submarine) sandwich as well as a machine or tool to grind or abrade objects or workpieces. In other geographic areas, the term “grinder” has several other meanings.

Typically, search engines such as Google®, Yahoo!®, MSN®, and the like, simply match keywords that are used in search queries to words that advertisers have incidentally provided in their ads along with a town, state, country or other geographic location. This approach simply combines keywords identifying geographic location terms with terms used to describe the ads as provided by the original author/advertiser. It does not take into consideration or refine the relationship of location and the words used in the search query. Rather, it simply extends or enlarges the number of the search query words that the typical search engine employs in analyzing the query. The results generated as a consequence of such logic is often a disjointed collection of information that is scattered among many geographic locations and among many synonymous goods/services associated with certain keywords or search terms.

Other advertising systems include the invention described in U.S. Pat. No. 7,047,242 (“'242 patent”) which uses categories such as “yellow page” categories that organize information into higher-level categories, so called “super-categories”, and then matches the ads to those super-categories. However, the '242 patent indicates that assigning ads to categories that are not super-categories would be time consuming and laborious. This approach dramatically reduces search relevancy and the ability to precisely target an audience.

Almost all online ad engines are focused on search engine queries and implicitly matching ads to search words. Local information does not fare well under this approach since it is not typically indexed properly by the search engines in the first place. That is to say, conventional “yellow page” search engines are either too specific, for example using a zip code or town, which eliminates neighboring opportunities, or too broad whereby they incorporate an entire state or country. Local information is generally relevant to a radius of users not only located in a single town or zip code. However, search results that encompass states and countries are not specific enough.

A need thus exists for those who publish local advertising information on the Web to quickly and easily index or categorize the information so that it can be found easily by searchers of such information. Equally if not more importantly for advertisers is the ability to categorize information with relevant advertising in a more automated fashion, thereby affording local advertisers the ability to place their ads in close association with relevant local information.

### SUMMARY OF THE INVENTION

The present invention includes a system and method for publishing local information on the Web to enable quick and easy indexing or categorization of the information so that it can be found easily by potential searchers. The invention enables information to be categorized with relevant advertising in a more automated fashion, thereby affording local advertisers the ability to place their ads in close association with relevant local information.

Initially, an author/publisher of content categorizes and assigns one or more geographic locations during the entry of the information into the system. The system then generates an Information Data Record (IDR) for the entry. Following generation of the IDR the system culls the content entered by the author for “relevant” and “irrelevant” words versus those contained in the system's database for the IDR record. High scoring relevant words are retained in the database and queried against one or more information category strings' natural word databases. The author-chosen information is then associated permanently with the associated information in the system.

In addition, advertisers also enter words to describe their advertisements (“ads”). The system then presents the advertiser with a list of categories and potential geographic locations based upon the relevant descriptive words from which the advertiser chooses appropriate categories and locations to display its ad. Preferably, the system also presents the advertiser with exposure projections for the category(s) and/or location(s) selected for the ad based upon historical evidence stored in the system.

Other details, objects and advantages of the present invention will become apparent as the following description of the presently preferred embodiments and presently preferred methods of practicing the invention proceeds.

### BRIEF DESCRIPTION OF THE DRAWINGS

The invention will become more readily apparent from the following description of preferred embodiments thereof shown, by way of example only, in the accompanying drawings wherein:

FIG. 1 is a flowchart showing how local information is entered, categorized, and stored on the Natural Targeted Advertising Engine system according to the invention;

FIG. 2 is a flowchart showing a presently preferred process by which the system according to the invention culls words entered by an author/publisher for relevant words to be stored in an information data record associated with information input by an author; and

FIG. 3 is an extension of FIG. 1 and shows how advertisements are entered into the system and assigned to category(s).

### DETAILED DESCRIPTION OF THE INVENTION

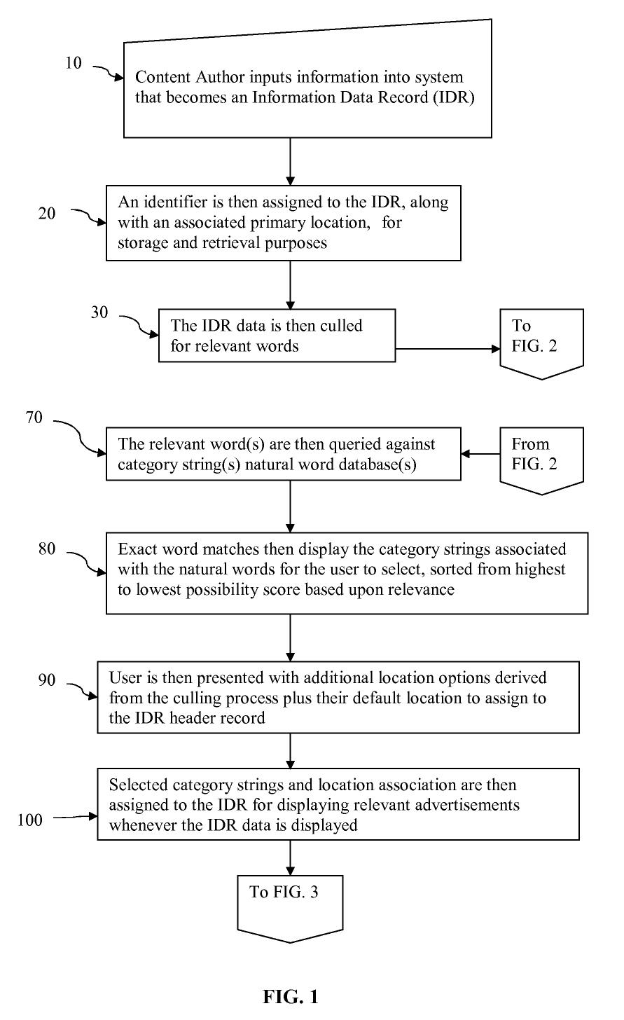

As represented by reference numeral 10 in FIG. 1 a user, i.e., a content author/publisher, enters into the system according to the invention content containing information which it desires to publish to the Web. Inputted content preferably includes information concerning geographic location and subject matter that may be of interest to potential advertisers seeking to place ads in close physical proximity to the content. The author's inputted information becomes an Information Data Record (IDR) in the system. The information to which an author desires to associate its content may be comprised of Web pages, Adobe® PDFs, images, etc. that are contained on a network of computers. At step 20, the system assigns a unique identifier to the IDR for storage and retrieval purposes and associates the IDR with a primary or default geographic location. The primary location may be assigned using the author's demographics, the location of the author's computer as defined by a network address geographic identifier, or a manual selection by the author. The primary or default and locations discussed herein may be any of zip code, county, state, region or other similar natural or man-made geographic based parameters. At step 30 completion of the IDR then starts the process of culling and further assigning geographic locations to the IDR.

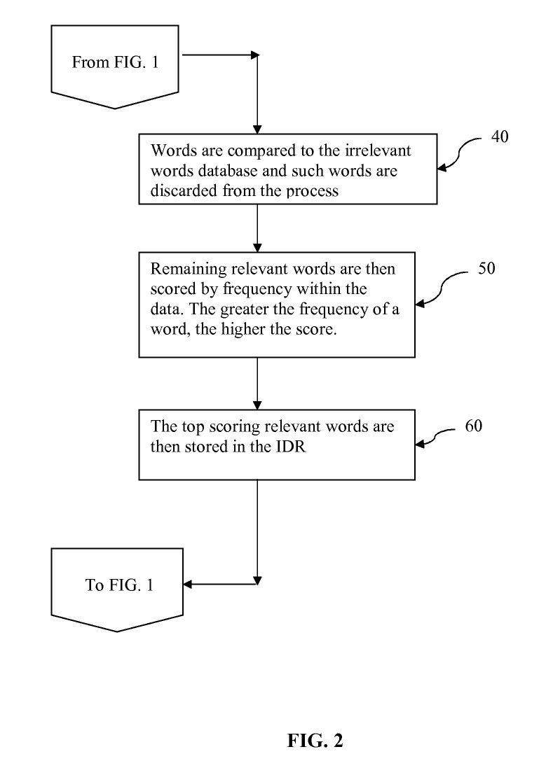

More particularly, as shown in FIG. 2, at step 40 the system compares all of the words in the IDR with the system's “irrelevant word database” and discards these words from the IDR. At step 50 the system scores the remaining “relevant” words as a function of their frequency within the entered data. The scoring may be based upon, for example, the top twenty words and the frequency of their appearance within the entered information (although it will be understood that greater or less than the top twenty frequently used words may be used as a “cut-off” for this purpose). Indeed, scoring is preferably a sliding scale that decreases as frequency diminishes. At step 60 the top twenty (or other desired number) of relevant words are then stored with the IDR. At this point, the culling process is complete and the system returns to step 70 in the process.

In this connection, referring again to FIG. 1, at step 70 the most frequent relevant words are then compared to the system's natural words category strings database. Category strings desirably include a category, a sub-category and a specialty category. Examples of category strings may include “Restaurant—Italian” or “Legal—Lawyer—Divorce”. When there is an exact match of word(s) the system assigns those category strings to the IDR for user approval. That is, at step 80 an author would be presented with the category string(s) that the system selected as relevant for the information entered by the author. The author would then select which category string(s) are best suited for the information. For example, if the word “grinder” was frequently used in the inputted information and the system database knows that “grinder” is a Philadelphia, Pa. area term for “sub sandwich”, the term “grinder” and the location “Philadelphia” are associated with category string(s) such as, for example, “Restaurant—Sub Sandwiches” and “Food—Sandwiches—Cheese Steak”. In this example the system would then assign these categories to the IDR for author approval. At step 90 the user is then presented with the one or more additional geographic locations—in addition to the author's primary or default location—that the system deems relevant to the information entered by the author. The author would then select the appropriate geographic location(s) most relevant to the entered information. At step 100 the system assigns the category strings and locations selected by the author as permanent parts of the IDR, which information is used to match local geographic ads to the relevant information whenever the IDR is displayed.

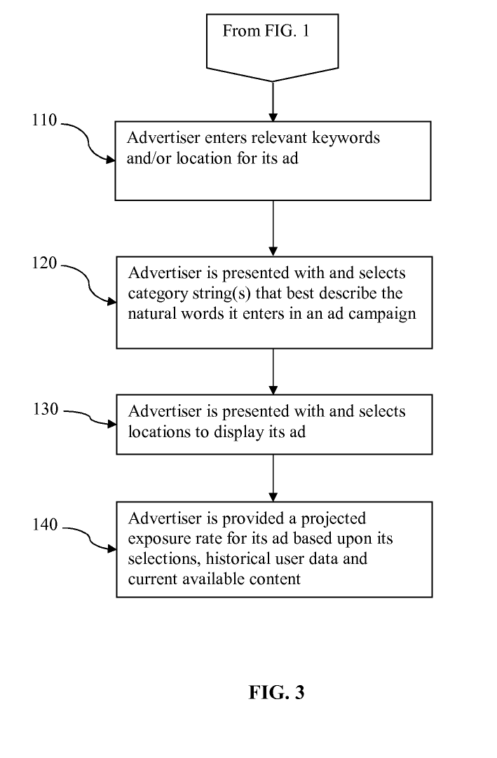

FIG. 3 is an extension of FIG. 1 and represents the manner in which an advertiser participates in the system according to the present invention. At step 110 an advertiser enters at least one geographic location and one or more words or keywords that describe products and/or services to be associated with its ad. At step 120 the system searches the category sting database and provides a list of category string(s) that are most relevant to the word(s) entered by the advertiser. The advertiser then selects the appropriate category strings for its ad. At step 130 the advertiser is presented with and selects one or more geographic location(s) from those that the system suggests for targeting the ad. The advertiser may also choose to select or add additional locations for targeting its ad that were not suggested as part of the automated process. At step 140, the advertiser is then desirably presented with an optional projection of expected exposure rate based upon its selections, historical user data and current information available in the system.

Although the invention has been described in detail for the purpose of illustration, it is to be understood that such detail is solely for that purpose and that variations can be made therein by those skilled in the art without departing from the spirit and scope of the invention as claimed herein.

What is claimed is:

1. A Web-based method for providing the ability to place a Web-based advertisement in close physical proximity to Web-based information that is relevant to the advertisement based upon the subject matter of the information and at least one geographic location, said method comprising the steps of:
(a) providing a computerized system including a computer accessible database for enabling a Web-based advertiser to select at least one geographic location and subject matter relevant to Web-based information such that an advertisement will be placed in close physical proximity to Web-based information relevant in subject matter to the advertisement when observed by searchers of the information; and
(b) selecting, by a Web-based advertiser, at least one geographic location and subject matter relevant to said Web-based information.

2. The method of claim 1 further comprising categorizing the Web-based advertisement information and assigning said at least one geographic location during entry of content into the system by an author.

3. The method of claim 1 wherein said assigning said at least one geographic location comprises assigning a primary geographic location to the information based upon author demographics, location of the author's computer defined by a network address geographic identifier or via manual author selection.

4. The method of claim 1 wherein the content entered by an author includes words to describe an advertisement and the system scores words within content entered by an author based upon frequency the words contained in the content.

5. The method of claim 1 wherein the system compares an author's content with a category strings database to assign at least one category string and at least one location for author approval.

6. The method of claim 5 wherein an author selects or the system automatically selects at least one category string and at least one location to assign to the content which is then permanently associated with the Web-based information in the system.

7. The method of claim 5 wherein said at least one category string comprises a main category, a sub-category and a specialty category.

8. The method of claim 5 further comprising providing a scoring system wherein most frequently used author words are then associated with Web-based information.

9. The method of claim 6 further comprising presenting an author with exposure projections for said at least one category string based upon the author's selections, historical user data and current information available in the system.
